(19) United States
(12) Patent Application Publication
(10) Pub. No.: US 2016/0253200 A1
(43) Pub. Date: Sep. 1, 2016

(54) SERVER VIRTUALIZATION METHOD OF MULTI NODE SYSTEM AND APPARATUS THEREOF

(71) Applicant: Electronics and Telecommunications Research Institute, Daejeon (KR)

(72) Inventors: Jin Suk MA, Daejeon (KR); Hag Young KIM, Daejeon (KR); Song Woo SOK, Daejeon (KR); Young Woo JUNG, Daejeon (KR)

(21) Appl. No.: 15/054,785

(22) Filed: Feb. 26, 2016

(30) Foreign Application Priority Data
Feb. 27, 2015 (KR) 10-2015-0028412

(51) Int. Cl. G06F 9/455; G06F 9/50

(52) U.S. Cl. CPC G06F 9/45558; G06F 9/5077; G06F 2009/45595

(57) ABSTRACT

Provided herein is a server virtualization method of a multi-node system, the server virtualization method comprising setting one of a plurality of computing nodes as a hypervisor master and at least one of remaining computing nodes as at least one hypervisor slave, allocating a virtual resource corresponding to each of the at least one hypervisor slave in the hypervisor master, and instructing, when a workload is input, a hypervisor slave determined based on a use state of the virtual resource corresponding to the each of the at least one hypervisor slave to process the workload.

### TECHNICAL FIELD

Various embodiments of the present invention relate to a server virtualization method of a multi-node system and an apparatus thereof, and more particularly, to a server virtualization method to allow system resources to be efficiently used by performing a parallel virtualization of a CPU and a memory in a multi-core system and an apparatus thereof.

### BACKGROUND OF THE INVENTION

In recent years, due to a rapid development of software technology, a server virtualization software technology which allows common server hardware to be used in a variety of user environments is being actively researched.

The server virtualization technology consists of a series of virtualization technologies using software techniques for an efficient use of server resources. Specifically, the server virtualization technology embodies a virtual resource of each resource in regard to server hardware resources such as a CPU, a memory, an interrupt, data, a network, and a storage by using the software techniques and allows a dedicated kernel to manage an embodied virtual resource. As a result, an embodied virtual resource is used in an operating system. As such, the server virtualization technology consists of a series of software configured to respond to an efficient use of the server resources, protection of server hardware, and a variety of user requirements.

A resource management operating system known as a hypervisor may be in charge of the server virtualization technology, and the hypervisor may be a key element of the server virtualization technology.

On the other hand, as low-power 64-bit multi-core CPU with high-performance has emerged, a development of low-power high-density server hardware becomes possible. Typical examples of commercially available high-performance of CPU with low power and high performance include an APM's X-Gene processor using 64-bit core, an AMD's processor Seattle, etc.

Server hardware that highly integrates a low-power and high-density core described above is known as a micro-server. In recent years, researches and developments have been going on regarding the micro-server in a variety of ways. The micro-server has advantages of a significantly lower operating power than existing server hardware, the number of operating cores, inexpensive hardware implementation cost, and a satisfactory server response performance, so that the micro-server is expected to create a new market in the field of cloud computing and network industries in the future.

The micro-server operates as a multi-node system by using a plurality of nodes implemented by a multi-core CPU and builds the server virtualization of the multi-node system. In a conventional multi-node system, when a particular node of a plurality of nodes stops, a management module identifies and blocks a power supplied to a corresponding node. In this case, a breakup is generated at a terminal of the user. In addition, when information about a node stopped in a service proxy server is not notified, a service proxy server may not identify whether the node stops or not, so that the service proxy server continuously requests the service as a stopped node.

Therefore, in the case of building the server virtualization in the multi-node system, a method for efficiently managing the resource of each node is required.

### DISCLOSURE OF THE INVENTION

### Technical Problem

Various embodiments of the present invention are directed to resolve the aforementioned problem of the conventional technology, that is, to provide a server virtualization method for using server resources efficiently by constituting a hypervisor master node and a hypervisor slave node when the server virtualization is embodied through a hypervisor in a multi-node system consisting of a multi-core CPU and including a plurality of computing nodes and an apparatus thereof.

### Technical Solution

A server virtualization method of the multi-node system according to the present invention for solving the aforementioned problems includes setting one of the plurality of computing nodes as a hypervisor master and at least one of remaining computing nodes as hypervisor slave, allocating a virtual resource corresponding to each of the at least one hypervisor slave, instructing, when a workload is input, a hypervisor slave determined based on a use state of the virtual resource corresponding to the each of the at least one hypervisor slave to process the workload.

In addition, the server virtualization apparatus of the multi-node system according to the present invention for solving the above problems includes a control unit which sets one of the plurality of computing nodes as the hypervisor master and at least one of the remaining computing nodes as the at least one hypervisor slave, allocating the virtual resource corresponding to each of the at least one hypervisor slave in the at least one hypervisor master, and instructing, when a workload is input, at least one hypervisor slave determined on the basis of the use state of the virtual resource corresponding to the each of the at least one the hypervisor slave to process the workload.

### Effects of the Invention

The server virtualization method and the apparatus thereof may distribute a workload corresponding to a client's request for the workload, and adjust an overload of a node of the hypervisor slave by allowing a node of the hypervisor master to share a resource of a node of the hypervisor slave.

In addition, the server virtualization method and the apparatus thereof may monitor an overload of the node of the hypervisor slave and reallocate the workload to another node of the hypervisor slave so that a specific node of the hypervisor slave does not reach an overload condition.

When a specific hypervisor slave node is in the overload condition, which is an abnormal state such as a kernel state or a time-out state upon a connection request, the hypervisor master node may block a virtual machine of corresponding node of the hypervisor slave. Even though the specific node of the hypervisor slave completely stops, the node of the hypervisor master may block a resource of a corresponding node of the hypervisor slave and an impact on the entire multi-node system. Thus, a server virtualization method of a multi-node system and an apparatus thereof according to the present invention provide an efficient virtual resource management method that may quickly and flexibly respond to a failure of a specific node.

### BRIEF DESCRIPTION OF THE DRAWINGS

FIG. 1 is a block diagram illustrating a logical structure of a server virtualization apparatus;

FIG. 2 is a block diagram illustrating a logical structure of a server virtualization apparatus according to the present disclosure in a single node system;

FIG. 3 is a block diagram illustrating a logical structure of a server virtualization apparatus according to the present disclosure in a multi-node system;

FIG. 4 is a block diagram illustrating a structure of a multi-node system in which a server virtualization apparatus according to the present disclosure is applied;

FIG. 5 is a block diagram illustrating a physical structure of a server virtualization apparatus according to the present disclosure; and

FIG. 6 is a flowchart illustrating a server virtualization method according to the present disclosure.

### DETAILED DESCRIPTION OF THE INVENTION

Hereinafter, embodiments of the invention will be described with reference to the accompanying figures in detail. The embodiments are provided to more sincerely and fully disclose the invention and to completely transfer the spirit of the invention to those skilled in the art to which the invention pertains, and the scope of the invention should be understood by the claims of the invention.

The terminology used herein is for the purpose of describing particular embodiments only and is not intended to be limiting of the invention. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

As used herein, the singular forms “a,” “an,” and “the” are intended to include the plural forms as well, unless the context clearly indicates otherwise.

Hereinafter, embodiments will be described in greater detail with reference to the accompanying drawings.

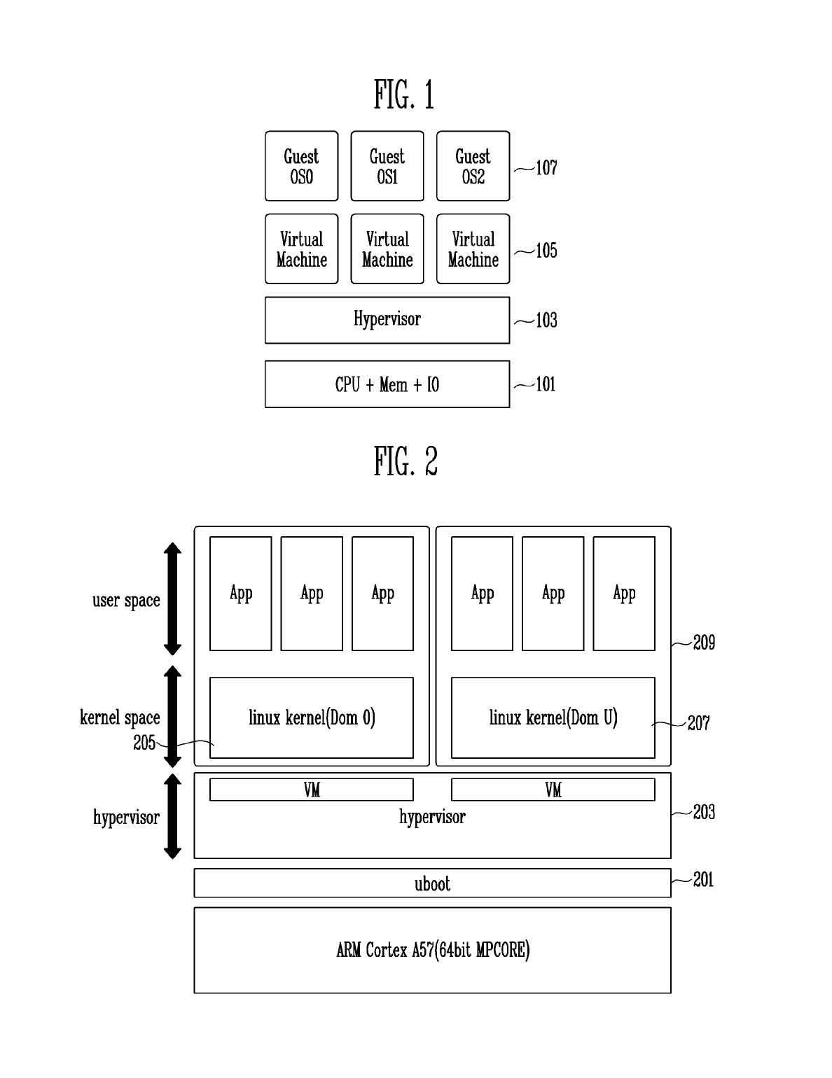

FIG. 1 is a block diagram illustrating a logical structure of a server virtualization apparatus.

Referring to FIG. 1, a server hardware resource 101 may include a CPU, a memory, 10, etc. A server virtualization apparatus may abstract server hardware by using a hypervisor 103 and manage the hardware. When booting the server virtualization apparatus initially, the hypervisor 103 may provide a plurality of virtual machines 105 (Virtual Machine; VM) so that the server hardware resource 101 is initialized and a plurality of guest operating systems 107 are executed on a top. Since a guest operating system 107 is interfaced via the virtual machine 105 which is a virtual resource provided by the hypervisor 103, the guest operating system 107 operates itself without identifying whether the hypervisor 103 exists or not.

When the server hardware resource 101 accesses in the guest operating system 107, the hypervisor 103 may be informed of the above information via a hypercall interface. The hypervisor 103 may control an operation of the guest operating system 107 by determining whether or not to accept an access of the guest operating system 107.

As described above, the server virtualization apparatus may drive a plurality of operation systems on one server hardware resource 101 via the hypervisor 103 without a limitation of driving one operating system corresponding to the one server hardware resource 101. The server virtualization may enable an efficient use of the server hardware resource 101 and provide a service-based technology to meet a user's need of a variety of operating systems.

In order to maximize benefits of the server virtualization described above, the hypervisor 103 needs to be implemented and the virtual machine 105 provided by an embodied hypervisor 103 may accommodate the guest operating system 107.

Recently, with the introduction of the hypervisor 103, structural complexity of the server operating system exponentially increases and functional complexity increases as functions of the hypervisor 103 and the virtual machine 105 expand so as to correspond to various operations of the guest operating system 107. Due to the increase of the structural and functional complexity, software configuration of a multi-core system also has been diversified, and complexity thereof increases compared to existing single server hardware and an existing single operating systems.

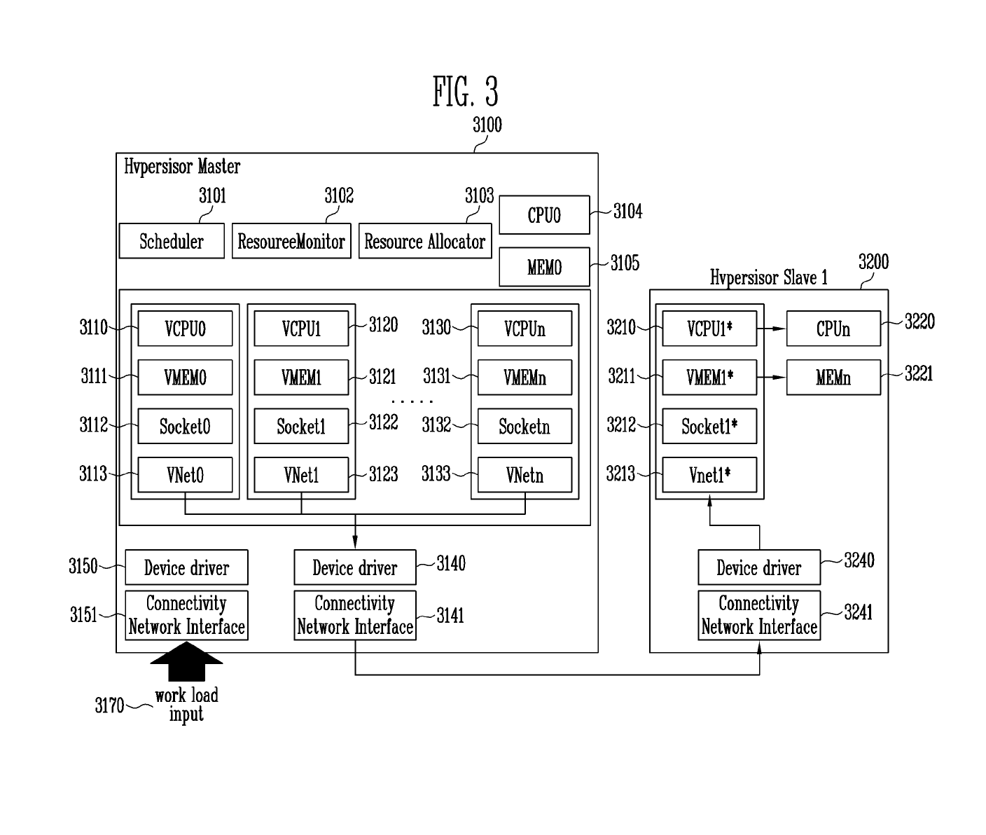

FIG. 2 is a block diagram illustrating a logical structure of a server virtualization apparatus according to the present disclosure in a single node system.

In systems in which the server virtualization is not used, the hypervisor does not need to be used. Thus, in a system that does not use the server virtualization, after a power is applied, a server board may call an operating system after achieving a simple system boot through a boot loader and converting a mode of a processor. A called operating system may be converted into a user space at the end of a corresponding process.

The server virtualization apparatus of a single node system according to the embodiment of the present disclosure, since the server virtualization using the hypervisor is applied, a system boot through the hypervisor may be performed.

Referring to FIG. 2, the server board may boot the hypervisor 203 rather than Linux kernels 205 and 207 after achieving system initialization through a boot loader 201. After the hypervisor 203 is booted, the Linux kernel 205 of a domain O (administrator domain, Dom O) region which should co-exist with the hypervisor 203. The Linux kernel 205 of domain O may deliver a variety of hyper calls to the hypervisor 203 with a logical structure closely associated with the hypervisor 203. After that, the Linux kernel (user kernel) 207 of a domain U region (guest domain, Dom U) may be booted.

When a boot process described above is completed, a user process may be ready to be performed on the domain 0 and the domain U and an application operation which developers and users desire may be performed by driving an appropriate application (App) process 209.

FIG. 3 is a block diagram illustrating a logical structure of a server virtualization apparatus according to the present disclosure in a multi-node system;

In the present invention, a plurality of computing nodes may be virtualized through the hypervisor, respectively, and the present invention provides a server virtualization method of the multi-node system connected to a system connectivity network.

In various embodiments of the present invention, the server virtualization apparatus may set arbitrary one of a plurality of nodes (computing nodes) to a hypervisor master node 3100 and the other node to a hypervisor slave 3200. In FIG. 3, for convenience of explanation, the case in which only one hypervisor slave 3200 exists is described, but a plurality of hypervisor slaves 3200 may be set, and an operation of the hypervisor slave 3200 to be described below may apply to the plurality of hypervisor slaves 3200.

Each node may be virtualized as a type 1 hypervisor for the server virtualization. The type 1 hypervisor may arrange the hypervisor on an upper layer of the hardware, and the guest operating system for the virtualization on an upper layer of the hypervisor.

The server virtualization apparatus according to the present invention may allocate the virtual resources for a hypervisor master 3100 in the hypervisor master 3100. Accordingly, the hypervisor master 3100 may include a virtual resource VCPU0 3110 by virtualizing a CPU resource CPU0 3104 of a node at which the hypervisor master 3100 is set, and a virtual resource VMEMO 3111 by virtualizing a memory resource MEM0 3105 of a node at which the hypervisor master 3100 is set.

The server virtualization apparatus according to the present invention may allocates the virtual resource for the hypervisor slave 3200 in the hypervisor slave 3200. Accordingly, the hypervisor slave 3200 may include a virtual resource VCPU1* 3210 by virtualizing a CPU resource CPU1 3220 of a node at which the hypervisor slave 3200 is set, and a virtual resource VMEM1* 3211 by virtualizing a memory resource MEM1 3221 of a node at which the hypervisor slave 3200 is set.

In various embodiments of the present invention, the server virtualization apparatus may allocate the virtual resource corresponding to each hypervisor slave 3200 in the hypervisor master 3100. The server virtualization apparatus may allocate the virtual resource by virtualizing the hardware resource of a node at which the hypervisor slave 3200 is set in the hypervisor master 3100. Accordingly, the hypervisor master 3100 may include a CPU resource CPU1 3220 of a node at which the hypervisor slave 3200 is set and virtual resources VCPU1 3120 and VMEM1 3121 by virtualizing a memory resource MEM1 3221. The hypervisor master 3100 may include the virtual resource corresponding to the hypervisor slave 3200 as the number of hypervisor slave 3200 set in the multi-node system. The virtual resources of the hypervisor slave 3200 allocated to the hypervisor master 3100 may enable the hypervisor master 3100 to directly control the hardware resource of the hypervisor slave 3200.

The hypervisor master 3100 and the hypervisor slave 3200 may include connectivity network interfaces 3141 and 3241 connecting therebetween. The connectivity network interfaces 3141 and 3241 may use the technology of PCIe and RapidIO as a dedicated network used to connect the nodes. The hypervisor master 3100 and the hypervisor slave 3200 may have the virtual resources VNet0 3113 and Vnet1* 3213 by virtualizing the connectivity network interfaces 3141 and 3241. The virtual resource VNet0 3113 may be a dedicated virtualization network interface which enables the node at which the hypervisor master 3100 is set to communicate with each virtualized node. In an embodiment of the present invention, the hypervisor master 3100 may also include a virtual resource Vnet1 3123 by virtualizing the connectivity network interfaces 3241 of the hypervisor slave 3200.

The hypervisor master 3100 and the hypervisor slave 3200 may include socket interfaces Socket0 3112 and Socket1* 3212 providing network service so as to use the virtualized network resources VNet0 3113 and Vnet1* 3213. In an embodiment of the present invention, the hypervisor master 3100 also may include the socket interfaces Socket1 3112 of the hypervisor slave 3200.

According to an embodiment of the present invention, the server virtualization apparatus may separately set the hypervisor master 3100 the hypervisor slave 3200 and efficiently control the hardware resource of the hypervisor slave 3200 through the hypervisor master 3100 by virtualizing the hardware resources of the hypervisor slave 3200 through the master hypervisor 3100.

When an arbitrary workload 3170 such as a web server access and a parallel programming message is input in the hypervisor master 3100 via the network interface 3151, a resource monitoring unit 3102 in the hypervisor master 3100 may monitor a use state of the virtual resource corresponding to the hypervisor slave 3200 and transmit a monitoring result to a resource allocating unit 3103. The resource allocating unit 3103 may determine a hypervisor slave 3200 with a smallest load as the slave hypervisor 3200 to allocate resources based on information on the use state of a received virtual resource. When the use of the resources is determined by the resource allocating unit 3103, a scheduler 3101 may instruct a determined hypervisor slave 3200 to process the workload 3170 through the connectivity network interfaces 3141 and 3241 by using a process scheduler for processing a task of the input workload 3170.

For example, on the basis of the use state of the virtual resource transmitted from the resource monitoring unit 3102, when the resource allocating unit 3103 determines to process the workload 3170 by using VCPU1 3120 and VMEM1 3121, the scheduler 3101 may instruct to process the workload 3170 to VCPU1* 3210, and VMEM1* 3211 in the hypervisor slave 3200 corresponding to the VCPU1 3120 and VMEM1 3121 respectively. The hypervisor slave 3200 which receives a processing instruction may process the workload 3170 by using CPU1 3220 and MEM1 3221, and notifies a processing result to the hypervisor master 3100.

In one embodiment, the server virtualization apparatus hypervisor slave 3200 may allocate a virtual resource corresponding to the hypervisor slave 3200 added in the hypervisor master 3100 or release a virtual resource allocated the hypervisor slave 3200 released in the hypervisor master 3100 when the hypervisor slave 3200 is additionally set at an arbitrary node (for example, when a node is added by a server capacity) or a previously set hypervisor slave 3200 is released (for example, when the node has been removed due to a server failure). That is, the hypervisor 3100 may dynamically allocate the hardware resources by simply adjusting virtual interface of the hypervisor slave 3100 when the hypervisor slave 3200 is added or released.

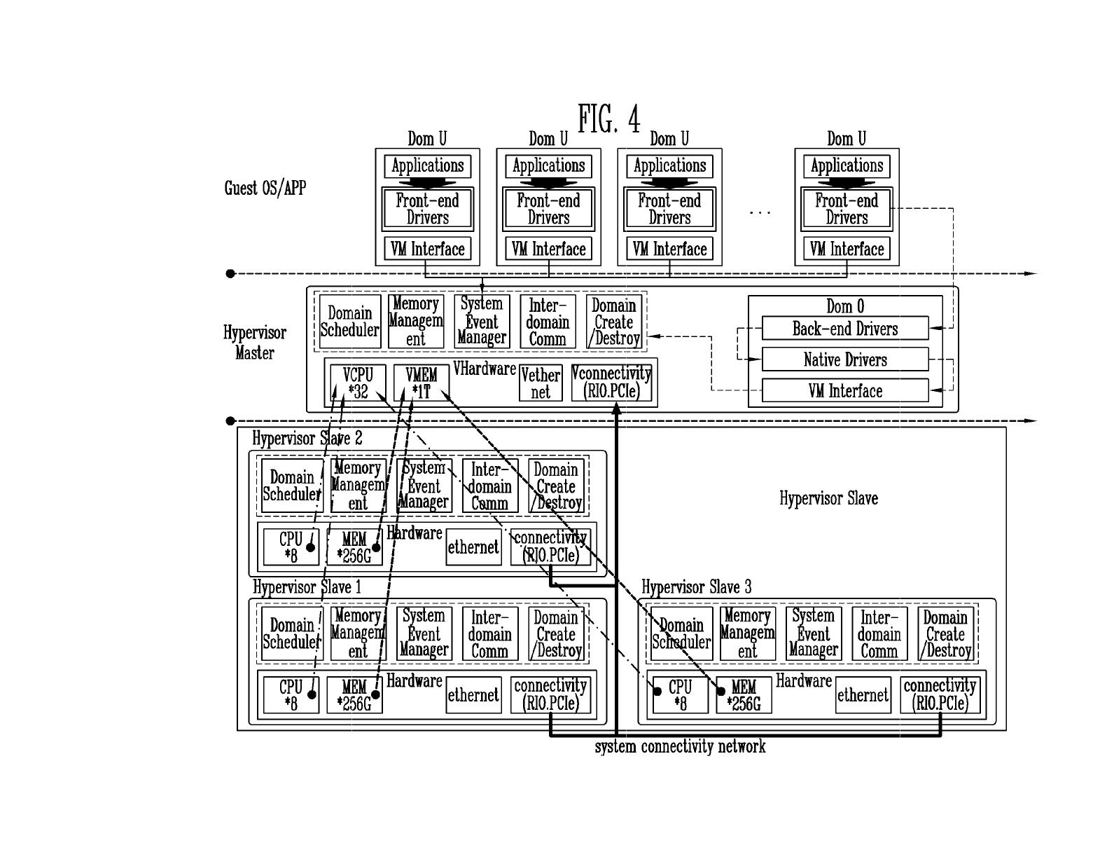

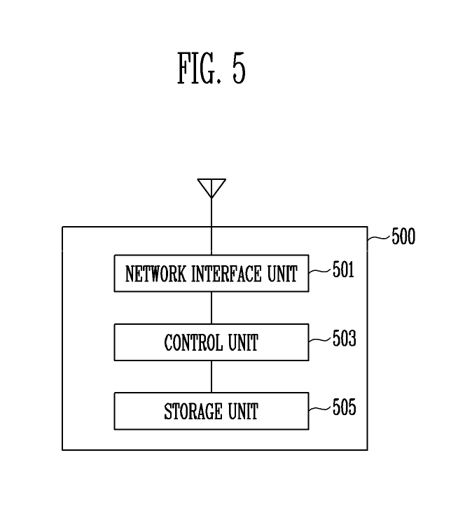

FIG. 4 is a block diagram illustrating a structure of a multi-node system in which a server virtualization apparatus according to the present disclosure is applied.

Referring to FIG. 4, the multi-node system according to the invention may separately set up the hypervisor master and at least one hypervisor slave, allocate a virtual resource corresponding to each hypervisor slave in at least one hypervisor master, and directly control the hardware resource of the hypervisor slave.

According to the present invention, by directly controlling at least one hypervisor slave through the hypervisor master, the user may recognize an entire system as a single computing system. That is, in view of an user application or a guest operating system, without additional considerations or settings as to what computing resource and what number of computing nodes consist of a corresponding server system, the server resource may be simply used by using the system resource provided from the hypervisor master.

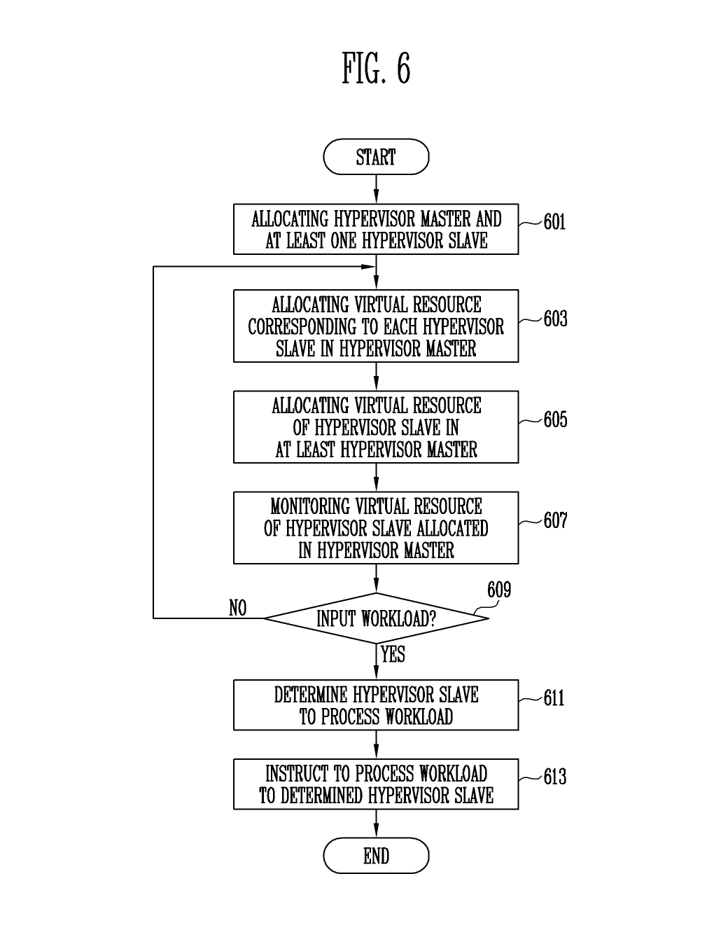

FIG. 5 is a block diagram illustrating a physical structure of a server virtualization apparatus according to the present disclosure.

Referring to FIG. 5, a server virtualization apparatus 500 according to the present invention may include a network interface unit 501, a control unit 503 and a storage unit 505.

The network interface unit 501 may perform data communication with an external resource. In an embodiment of the present invention, the network interface unit 501 may receive the workload from the external resource, or send the processing result of the workload to the external resource.

The control unit 503 may control components of the server virtualization apparatus 500 for the server virtualization. Specifically, the control unit 503 may constitute and control the multi-node system in the server virtualization apparatus 500. The control unit 503 may set one of a plurality of nodes as the hypervisor mater and at least one of remaining nodes as the hypervisor slave, and allocate the virtualization resource by virtualizing the hardware resource in the hypervisor master and the hypervisor slave. In particular, in an embodiment of the present invention, the control unit 503 may virtualize the hardware resource of each hypervisor slave, monitor the hardware resource of the hypervisor slave, and instruct a hypervisor slave with a small the amount of resources to process the workload when the workload has been input.

In an embodiment, the control unit 503 may provide the CPU resource as the hardware resource.

Detailed operation of the control unit 503 is the same as the description referring to FIGS. 2 to 4.

The storage unit 505 may store a program, information and data required for an operation of the server virtualization apparatus 500. In an embodiment of the present invention, the storage unit 505 may provide the memory resource as the hardware resource.

FIG. 6 is a flowchart illustrating a server virtualization method according to the present disclosure.

Referring to FIG. 6, the server virtualization apparatus set one of a plurality of computing nodes as the hypervisor master, and at least one of remaining computing nodes as the hypervisor slave 601.

The server virtualization apparatus may allocate the virtual resource corresponding to at least one hypervisor slave in the hypervisor master 603. The server virtualization apparatus may allocate the virtual resource by virtualizing the hardware resource of at least one hardware resource of the hypervisor slave in the hypervisor master. In addition, the server virtualization apparatus may allocate the virtual resource by virtualizing the hardware resource of the hypervisor master in the hypervisor.

In addition, the server virtualization apparatus may allocate 605 the virtual resource by virtualizing the hardware resource of the master slave in the hypervisor slave.

Thereafter, the server virtualization apparatus may monitor the virtual resource corresponding to at least one hypervisor slave allocated in the hypervisor master 607. The server virtualization apparatus may check the use state of the virtual resource of each hypervisor slave through monitoring. In an embodiment, the use state of the virtual resource of each hypervisor slave may be checked when the arbitrary workload is input as described below even through the use state is not monitored in advance.

When the arbitrary workload is input 609, the server virtualization apparatus may determine the hypervisor slave to process the input workload based on the monitoring results 611. The server virtualization apparatus may select the least amount of virtual resources after monitoring the use state of the virtual resource. The server virtualization apparatus may determine the hypervisor slave corresponding to a selected virtual resource as the hypervisor slave to process the input workload.

The server virtualization apparatus may instruct a determined hypervisor slave to process 613. The hypervisor master may instruct the hardware resource of a determined hypervisor slave to process an input workload.

According to the server virtualization method of the server virtualization apparatus, the server virtualization apparatus may efficiently integrate and manage the virtual resource of the plurality of hypervisor slaves via the hypervisor master, and simply control the multi-node system by adding and releasing the virtual resource in the hypervisor master when adding and changing the hypervisor slave.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

### DESCRIPTION OF REFERENCE NUMERALS

101: A server hardware resource
103: A hypervisor
105: A virtual machine
107: A guest operating system

1. A server virtualization method of a multi-node system, the server virtualization method comprising:
setting one of a plurality of computing nodes as a hypervisor master and at least one of remaining computing nodes as at least one hypervisor slave;
allocating a virtual resource corresponding to each of the at least one hypervisor slave in the hypervisor master; and
instructing, when a workload is input, a hypervisor slave determined based on a use state of the virtual resource corresponding to the each of the at least one hypervisor slave to process the workload.

2. The server virtualization method according to claim 1, wherein the virtual resource corresponding to the each of the at least one hypervisor slave is a virtualized hardware resource of the computing node at which the at least one hypervisor slave is set.

3. The server virtualization method according to claim 1, wherein the virtual resource corresponding to the each of the at least one hypervisor slave is allocated so that the hypervisor master directly controls a hardware resource of the computing node at which the at least one hypervisor slave is set.

4. The server virtualization method according to claim 1, wherein the workload is processed through a hardware resource of the computing node at which the hypervisor slave determined based on the use state of the virtual resource is set.

5. The server virtualization method according to claim 1, further comprising monitoring the use state of the virtual resource for the at least one hypervisor slave allocated in the hypervisor mater.

6. The server virtualization method according to claim 1, further comprising releasing the virtual resource corresponding to a released hypervisor slave when a hypervisor slave set at an arbitrary computing node is released.

7. A server virtualization apparatus of a multi-node system, the server virtualization apparatus comprising:
a network interface unit receiving a workload from a network; and
a control unit setting one of a plurality of computing nodes as a hypervisor master and at least one of remaining computing nodes as at least one hypervisor slave, allocating a virtual resource corresponding to each of the at least one hypervisor slave in the hypervisor master, and instructing, when a workload is input, a hypervisor slave determined based on a use state of the virtual resource corresponding to the each of the at least one hypervisor slave to process the workload.

8. The server virtualization apparatus according to claim 7, wherein the control unit comprises:
a resource allocating unit determining a hypervisor slave to process the workload based on the use state of the virtual resource corresponding to the each of the at least one hypervisor slave when the arbitrary workload is input; and
a scheduler instructing the hypervisor slave determined based on the use state of the virtual resource to process the workload.

9. The server virtualization apparatus according to claim 7, wherein the virtual resource corresponding to the each of the at least one hypervisor slave virtualizes a hardware resource of the computing node at which the at least one hypervisor slave is set.

10. The server virtualization apparatus according to claim 7, wherein the virtual resource corresponding to the each of the at least one hypervisor slave is allocated so that the hypervisor master directly controls a hardware resource of the computing node at which the at least one hypervisor slave is set.

11. The server virtualization apparatus according to claim 7, wherein the workload is processed through a hardware resource of the computing node at which the hypervisor slave determined based on the use state of the virtual resource is set.

12. The server virtualization apparatus according to claim 7, wherein the control unit includes a resource monitoring unit monitoring the use state of the virtual resource for the at least one hypervisor slave allocated in the hypervisor master.

13. The server virtualization apparatus according to claim 7, wherein when a hypervisor slave set at an arbitrary computing node is released, the control unit releases the virtual resource corresponding to a released hypervisor slave.

14. The server virtualization apparatus according to claim 7, further comprising a connectivity network interface connecting the hypervisor master and the at least one hypervisor slave.
